(19) United States
(12) Patent Application Publication
(10) Pub. No.: US 2016/0037263 A1
(43) Pub. Date: Feb. 4, 2016

(54) ELECTROSTATIC MICROPHONE WITH REDUCED ACOUSTIC NOISE

(71) Applicant: Knowles Electronics, LLC, Itasca, IL (US)

(72) Inventors: Sagnik Pal, Schaumburg, IL (US); Lance Barron, Plano, TX (US); Sung Lee, Chicago, IL (US)

(21) Appl. No.: 14/808,135

(22) Filed: Jul. 24, 2015

Related U.S. Application Data
(60) Provisional application No. 62/032,829, filed on Aug. 4, 2014.

(51) Int. Cl. H04R 7/14; H04R 7/18

(52) U.S. Cl. CPC H04R 7/14; H04R 7/18

(57) ABSTRACT

A micro electro mechanical system (MEMS) microphone includes a base; a MEMS die disposed on the base; and a cover coupled to the base and enclosing the MEMS die. The MEMS die includes and diaphragm and back plate and posts extend from a first periphery of the back plate. The diaphragm is free to move within a boundary created by the posts. A front volume is formed on a first side of the diaphragm and a back volume is formed on a second side of the diaphragm between the diaphragm and the cover. A plurality of openings extend through the diaphragm about an outer periphery of the diaphragm, the openings being effective to mitigate noise.

### CROSS REFERENCE TO RELATED APPLICATION

This patent claims benefit under 35 U.S.C. §119 (e) to U.S. Provisional Application No. 62/032,829 entitled “Electrostatic Microphone with reduced acoustic noise” filed Aug. 4, 2014, the content of which is incorporated herein by reference in its entirety.

### TECHNICAL FIELD

This application relates to microphones and, more specifically to diaphragms in these microphones.

### BACKGROUND OF THE INVENTION

Various types of microphones and receivers have been used through the years. In these devices, different electrical components are housed together within a housing or assembly. Other types of acoustic devices may include other types of components. These devices may be used in hearing instruments such as hearing aids, personal audio headsets, or in other electronic devices such as cellular phones and computers.

One type of microphone is a micro electro mechanical system (MEMS) microphone. The MEMS microphone uses a MEMS die that supports a diaphragm and a back plate. When the diaphragm deforms/moves due to changing sound pressure, the electrical potential between the microphone and the back plate changes to produce an electrical signal that is representative of the incident sound pressure. The diaphragm typically divides the microphone into a front volume and a back volume.

Some microphones use free plate diaphragm. A free plate diaphragm is typically disposed between the back plate and the substrate. The free plate diaphragm is not constrained at its boundary and consequently is free to move. As the free plate diaphragm deforms/moves in the presence of sound pressure, air flow leakage occurs between the front volume and the back volume. The portion of the diaphragm overlapping the substrate, is typically very close to the substrate. Up and down motion of the overlapping region of the diaphragm results in squeeze film damping. As a consequence of damping, unwanted and undesirable noise is produced.

This damping is a limiting factor to achievable microphone signal-to-noise ratio.

### BRIEF DESCRIPTION OF THE DRAWINGS

For a more complete understanding of the disclosure, reference should be made to the following detailed description and accompanying drawings wherein:

FIG. 1 comprises a diagram of a MEMS microphone according to various embodiments of the present invention;

FIG. 2 comprises a side cutaway view of portions of a MEMS microphone according to various embodiments of the present invention;

FIG. 3 comprises a top view of the MEMS microphone of FIG. 2 according to various embodiments of the present invention;

FIG. 4 comprises a view of a portion of the MEMS microphone of FIG. 2 and FIG. 3 according to various embodiments of the present invention;

FIG. 5 comprises a side cutaway view of portions of a MEMS microphone according to various embodiments of the present invention;

FIG. 6 comprises a top view of the MEMS microphone of FIG. 2 according to various embodiments of the present invention;

FIG. 7 comprises a view of a portion of the MEMS microphone of FIG. 2 and FIG. 3 according to various embodiments of the present invention;

FIG. 8 comprises a graph show aspects of the operation of the microphones described herein according to various embodiments of the present invention;

FIG. 9 comprises a perspective drawing of a portion of a microphone apparatus according to various embodiments of the present invention;

FIG. 10 comprises a perspective cut-away drawing of a portion of a microphone apparatus taken along line A-A in FIG. 9 according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

In the approaches described herein, a MEMS microphone having a free plate diaphragm and with improved operating performance is provided. In one aspect, holes or openings may be provided around an outer periphery of the diaphragm in order to mitigate noise. In another aspect, a flow-constrainer (or other resistive element) is provided or disposed around the outer periphery of the diaphragm (or around portions of the outer periphery of the diaphragm) in order to reduce air flow into the back volume of the microphone. In other examples, both holes and a flow-constrainer are provided. In yet another example, a combination of vent holes and a flow-constrainer (or other resistive element) may be implemented. The approaches provided herein are easy and cost effective to implement and result in better microphone performance and user satisfaction with the microphone.

It will be appreciated that the examples presented in this disclosure have been exemplified using MEMS microphones. However, the approaches described herein are general and widely applicable to various microphone architectures and are in no way limited to MEMS microphones.

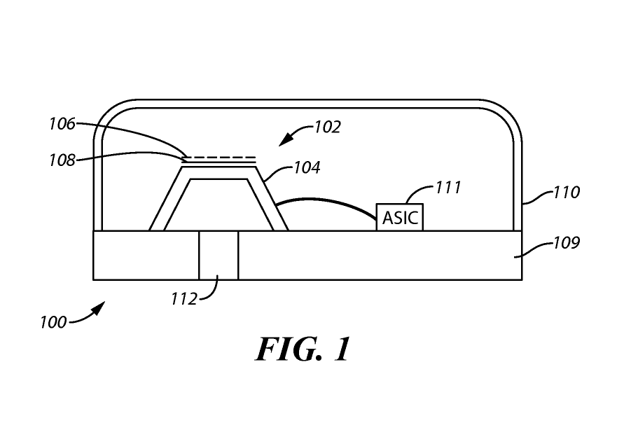

Referring now to FIG. 1, one example of a MEMS microphone 100 is described. The microphone 100 includes a MEMS device 102 (including a MEMS die or substrate 104, a back plate 106, and a diaphragm 108), a base 109, a lid or cover 110, an integrated circuit (IC) 111 (that performs various processing functions on the received signal), and a port 112. In the example shown in FIG. 1, the microphone 100 is a bottom port device. That is, the port 112 extends through the base 109 (rather than the lid 110). Alternatively, the microphone may be a top port device where the port 112 extends through the cover 110. In another aspect, the microphone 100 may be a MEMS-on-lid microphone where the port 112 extends through the lid and the MEMS device 102 is disposed on the lid 110.

The diaphragm 108 is a free plate diaphragm that is not secured about its outer periphery. In one aspect, holes or openings may be provided around an outer periphery of the diaphragm 108 in order to mitigate noise. In another aspect, a flow-constrainer (or other resistive element) is provided around the outer periphery of the diaphragm 108 (or around portions of the outer periphery of the diaphragm 108) in order to reduce air flow into the back volume of the microphone 100. In other examples, both holes and a flow-constrainer are provided.

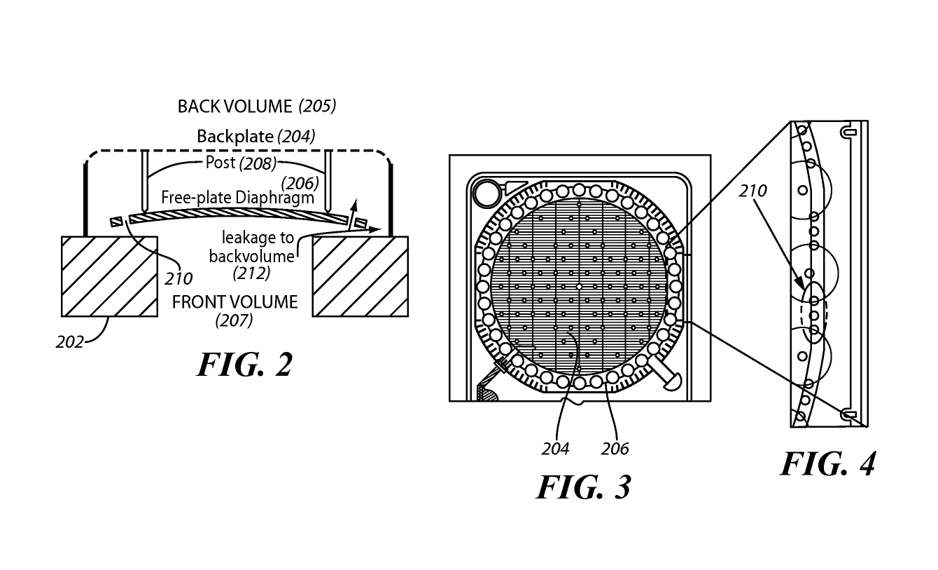

Referring now to FIG. 2, FIG. 3, and FIG. 4, one example of a MEMS microphone 200 is described. The microphone 200 includes a MEMS die 202 a back plate 204 and a diaphragm 206. Posts 208 extended from the back plate 204. A back volume 205 and front volume 207 exists.

In one aspect, capacitive detection may be used to detect diaphragm motion/deformation. In this embodiment, a bias voltage is typically applied between the diaphragm 206 and the back plate 204. The capacitance between the back plate and the diaphragm varies about quiescent value when sound energy is received by the microphone 200. Consequently, sound energy is converted into an electrical signal and the electrical signal represents the sound energy that is received. In another example, an electret is used to establish a bias between the back plate and the diaphragm. Besides capacitive detection, transduction may be achieved by other mechanisms as well. An incomplete list of transduction mechanisms include piezoresistive, piezoelectric, magnetostrictive, and optical mechanisms for detecting the movement/deformation of the active component of the microphone. Other examples are possible.

The diaphragm 206 is free to move within the boundaries of the post and the space where it is disposed. Other structures may also be used to restrain the diaphragm 206, but the diaphragm 206 is not restrained about the entirety of its outer periphery. In one aspect, the free-plate diaphragm 206 is restrained in a small region of the diaphragm periphery. In this region and in one example, an approximately 10 microns wide “runner” connects the diaphragm to the MEMS substrate. Without any restriction, the diaphragm position may be somewhat unpredictable and hard to control.

Holes or openings 210 extend through the diaphragm 206 in order to mitigate noise. In one example, the holes or openings 210 are approximately 5 microns wide. Other dimensions are possible.

As shown, air flows in the direction indicated by the arrows labeled 212. The holes 210 around the periphery of the diaphragm 206 reduce, for example, squeeze film damping or any aerodynamic damping between the diaphragm 206 and the MEMS die 202 thereby mitigating noise and improving system performance.

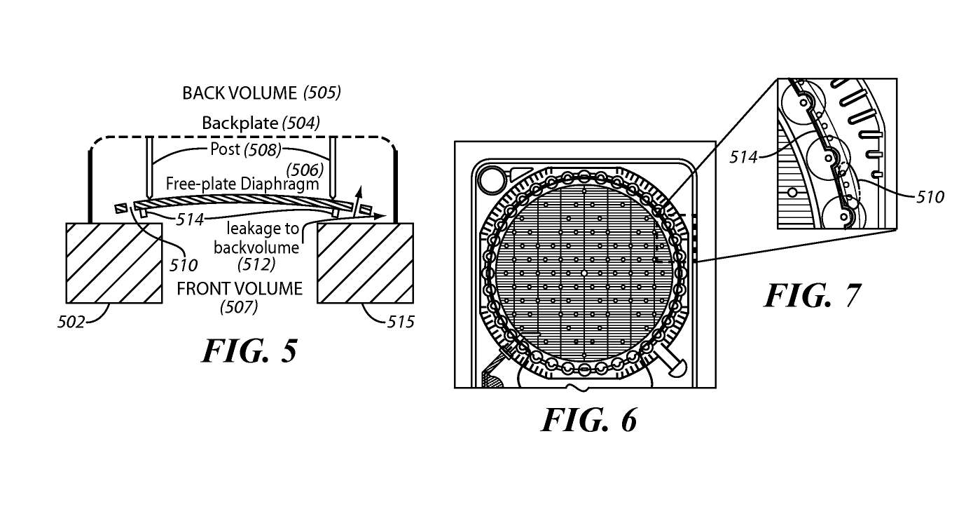

Referring now to FIG. 5, FIG. 6, and FIG. 7, another example of a MEMS microphone 500 is described. The microphone 500 includes a MEMS die 502, a back plate 504, and a diaphragm 506. Posts 508 extend from the back plate 504.

The diaphragm 506 and the back plate 504 operate to create an electrical potential. As the diaphragm 506 moves in the present of sound, an electrical potential is created and changes between the back plate 504 and the diaphragm 506. Consequently, sound energy is converted into an electrical signal and the electrical signal represents the sound energy.

The diaphragm 506 is free to move within the boundaries of posts 508 and the space where it is disposed. Other restraining structures may also be used to restrain movement of the diaphragm 506. A back volume 505 and a front volume 507 exist and are separated by the diaphragm 506.

Holes or openings 510 extend through the diaphragm 506 and operate to mitigate noise. In one example, the holes or openings 210 are approximately 5 microns wide. Other dimensions are possible. As shown, air flows in the direction indicated by the arrows labeled 512. The holes 510 around the periphery of the diaphragm 506 reduce squeeze film damping between the diaphragm 506 and the MEMS die 502 thereby reducing noise.

A flow-constrainer 514 is disposed about the periphery of the diaphragm 506. The flow-constrainer 506 may be an integrally formed part of the back plate 504, an integrally formed part of the diaphragm 506, or a separate element that is connected to either the diaphragm 506 or the back plate 504 or the MEMS substrate 515. The flow-constrainer 514 limits air leakage into the back volume of the microphone 500. The flow-constrainer 514 may be a full (complete) ring or may comprise multiple segments.

The holes 510 and the flow-constrainer 514 are two structures whose use, dimensions, and structure advantageously allow a designer to control damping noise and leakage into the back volume. By controlling both the holes 510 (e.g., size and number) and the dimensions of the flow-constrainer 514, optimum system performance can be achieved.

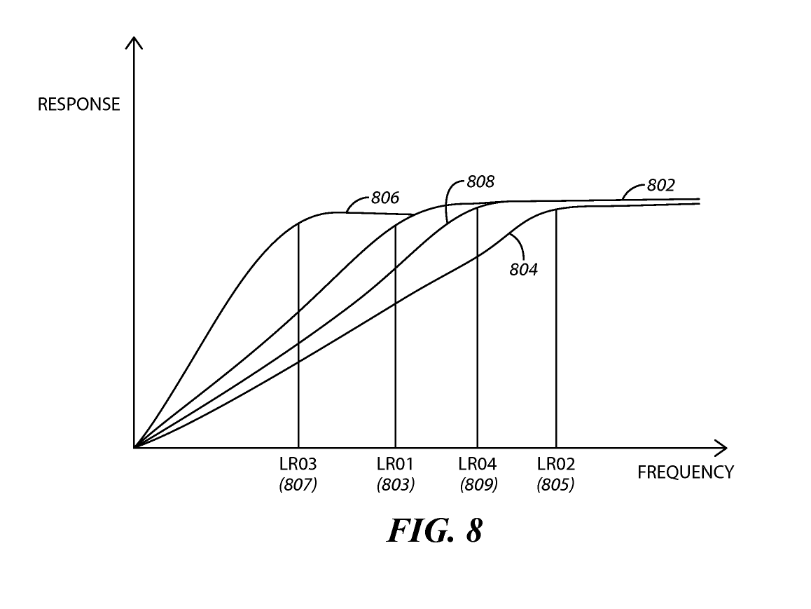

Referring now to FIG. 8, one example of a graph showing some of the advantages of the present approaches is descried. As shown, the graph represents values of frequency on the x-axis and represents values for the response of the microphone on the y-axis.

A first curve 802 represents the response for a microphone that does not use periphery holes or flow-constrainer. The response has a low frequency response value 803 (LR01).

A second curve 804 represents the response for a microphone that uses periphery holes in the diaphragm as has been described herein. This response has a higher value for the low frequency response 805 (LR02).

A third curve 806 represents the response for a microphone that uses only a flow-constrainer. This response has a lower value for the low frequency response 807 (LR03) as compared to the low frequency response value 803.

A fourth curve 808 represents the response for a microphone that uses both periphery holes and a flow-constrainer. This response has a low frequency response 809 (LR04). The low frequency response 809 (LR04) lies between the low frequency response (LR01) 803 (where no periphery holes or flow-constrainer are used) and the low frequency response (LR02) 805 (where only periphery holes are used).

Advantageously, it can be appreciated that the low frequency response regions (and frequency values) are fine tuned. Thus, a designer can design a microphone that achieves optimum performance.

It will be appreciated that the present approaches are described with respect to a bottom port microphone (that is, a microphone with a port extending through the base). However, the present approaches are widely applicable to various port configurations. A partial list includes top port devices (e.g., microphones where the sound port extends through the lid or cover); MEMS on lid devices (where the MEM die is secured to the lid or cover and the post extends through the lid or cover); side-port devices etc. (where the port is located on the lid wall adjacent to the base).

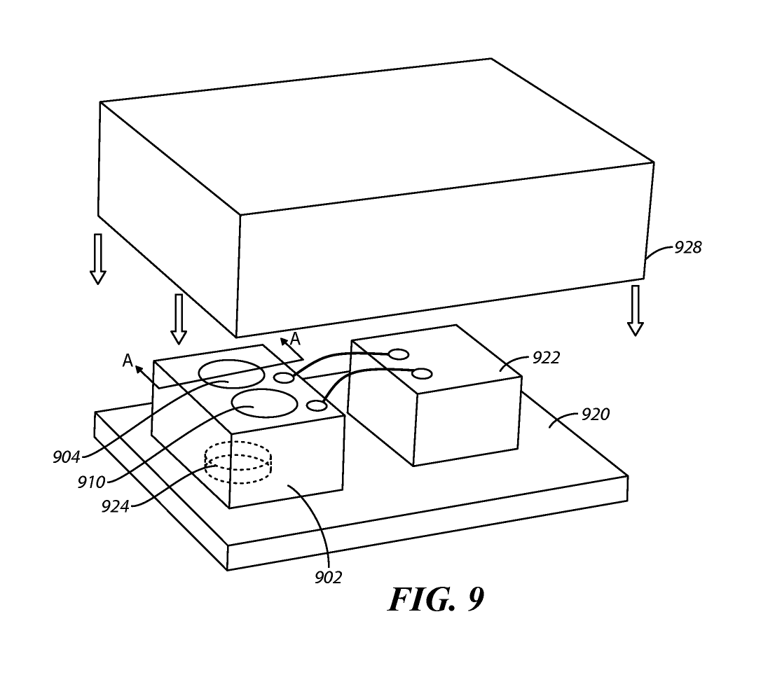

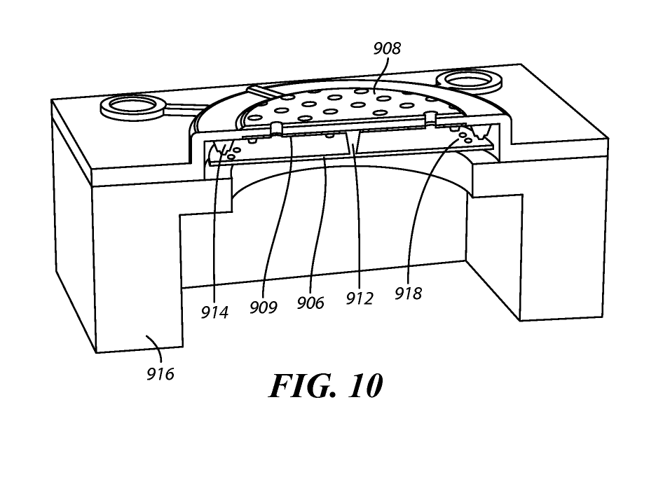

Referring now to FIG. 9 and FIG. 10, a microphone 900 includes cover 928, MEMS device 902, ASIC 922, substrate 920, port 924. The MEMS device 902 includes two MEMS motors 904 and 910 each with a diaphragm 906 and back plate 908. The diaphragm 906 is attached to a pillar 912.

In other examples, the diaphragm 906 may not be physically attached to the pillar 912. In the example shown in FIGS. 9 and 10, there are posts 914 near the periphery of the motor. When electrical bias is applied between the diaphragm 906 and a back plate electrode 909, the diaphragm 906 engages with the posts 914. In other examples, there may be no posts at the motor periphery.

Similar to the examples of FIG. 2 and FIG. 5, holes or openings 918 are incorporated in the diaphragm of the example of FIG. 9 and FIG. 10 to act as damping countermeasure. These openings 918 couple the front volume and the back volume of the microphone.

Similar to the example of FIG. 5, flow-constrainer (or other resistive element) may be incorporated in the embodiment described in the example of FIG. 9 and FIG. 10.

It will be appreciated that the examples herein, the whole diaphragm or portions of the diaphragm may be rigid, and the MEMS output may be generated by rigid body motion.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A micro electro mechanical system (MEMS) microphone, the microphone comprising:
a base;
a MEMS die disposed on the base;
a cover coupled to the base and enclosing the MEMS die;
wherein the MEMS die includes and diaphragm and back plate;
wherein posts extend from a periphery of the back plate;
wherein the diaphragm is free to move within a boundary created by the posts;
wherein a front volume is formed on a first side of the diaphragm and a back volume is formed on a second side of the diaphragm between the diaphragm and the cover;
wherein a plurality of openings extend through the diaphragm about an outer periphery of the diaphragm, the openings being effective to mitigate noise.

2. The MEMS microphone of claim 1, further comprising an application specific integrated circuit.

3. The MEMS microphone of claim 1, further comprising a runner coupled to the diaphragm to further restrain diaphragm movement.

4. The MEMS microphone of claim 1, further comprising a flow restrainer disposed between the openings and the front volume.

5. The MEMS microphone of claim 1, wherein the base includes a port that communicates with the front volume.

6. The MEMS microphone of claim 5, wherein sound enters through the port.

7. The MEMS microphone of claim 1, openings are approximately 5 microns in diameter.

8. An acoustic apparatus, comprising:
a diaphragm;
a back plate;
posts that extend from a periphery of the back plate;
wherein the diaphragm is free to move within a boundary created by the posts;
wherein a front volume is formed on a first side of the diaphragm and a back volume is formed on a second side of the diaphragm between the diaphragm and a microphone cover;
wherein a plurality of openings extend through the diaphragm about an outer periphery of the diaphragm, the openings being effective to mitigate noise in a microphone.

9. The acoustic apparatus of claim 8, further comprising a runner coupled to the diaphragm to further restrain diaphragm movement.

10. The acoustic apparatus of claim 8, openings are approximately 5 microns in diameter.

11. A micro electro mechanical system (MEMS) microphone, the microphone comprising:
a base;
a MEMS die disposed on the base;
a cover coupled to the base and enclosing the MEMS die;
wherein the MEMS die includes and diaphragm and back plate;
wherein a front volume is formed on a first side of the diaphragm and a back volume is formed on a second side of the diaphragm between the diaphragm and the cover;
wherein a plurality of openings extend through the diaphragm about an outer periphery of the diaphragm, the openings being effective to mitigate noise.

12. The MEMS microphone of claim 11, further comprising a flow restrainer disposed between the openings and the front volume.
